(19) United States
(12) Patent Application Publication
(10) Pub. No.: US 2011/0022399 A1
(43) Pub. Date: Jan. 27, 2011

(54) Auto Detection Method for Frame Header

(75) Inventor: CHU-FENG LIEN, Hsinchu Hsien (TW)

Correspondence Address: WPAT, PC;INTELLECTUAL PROPERTY ATTORNEYS, 7225 BEVERLY ST., ANNANDALE, VA, 22003, US

(73) Assignee: MStar Semiconductor, Inc., Hsinchu Hsien (TW)

(21) Appl. No.: 12/841,701

(22) Filed: Jul. 22, 2010

(30) Foreign Application Priority Data
Jul. 22, 2009 (TW) 098124658

(51) Int. Cl. G10L 19/00

(52) U.S. Cl. 704/500; 704/E19.001

(57) ABSTRACT

A method for auto-detecting a frame header is provided. By searching and comparing content of input frames and predetermined sync words, decoding efficiency is increased and the probability of incurring program errors is reduced. Once decoding errors occur, an auto-recovery mechanism soon recovers the audio decoding system operation.

### CROSS REFERENCE TO RELATED PATENT APPLICATION

This patent application is based on Taiwan, R.O.C. patent application No. 098124658 filed on Jul. 22, 2009.

### FIELD OF THE INVENTION

The present invention relates to the Advance Audio Coding (AAC) technology, and more particularly, to an auto detection method for an AAC frame header.

### BACKGROUND OF THE INVENTION

MP3 has prevailed worldwide. Two important audio compression standards, the AAC (MPEG-2) and the latest HE-AAC (high-efficiency AAC) (MPEG-4) standards, based on development of the MPEG technology, are further developed. According to the HE-AAC techniques applying the AAC techniques and the spectral band replication (SBR) techniques, compression efficiency increases by at least 30% from that of the AAC techniques.

FIG. 1 is a diagram showing a relationship among a transport stream (TS), an audio packetized elementary stream (PES) and a frame. An AAC bit stream is based on frames, each comprising a frame header and a frame raw data block. A common frame raw data block comprises 2048, 1024, 512 or 256 time-domain sampling points. In the AAC standard, an audio data transport stream (ADTS) header is defined for each frame. With respect to the HE-AAC standard, a low-overhead audio stream (LOAS) header or a low-overhead MPEG-4 audio transport multiplex (LATM) header is defined for each frame to record associated decoding information for the frame. The frame is encapsulated into the audio PES. The audio PES is further encapsulated into TS packets for transmission in noisy environment.

A common TS bit stream, possibly being a mix of the foregoing two audio standards, is received and followed by its TS packets parsed by a stream information parser at a receiving end. When a value in a stream type field of a TS packet is 0xF (e.g., a value in a stream type field in a program map table (PMT)), it indicates that this audio PES supports the MPEG-2 AAC audio compression standard and embeds an ADTS header therein. A conventional stream information parser fills a sync word 0xFFF of the ADTS header into an audio decoder before decoding, so that an AAC decoder identifies the ADTS header or an ADTS frame according to a stream of input frames. Moreover, when a value in the stream type field of the TS packet equals 0x11, the audio PES supports the MPEG-4 HE-AAC audio compression standard and a frame inside the audio PES possesses a LOAS header or a LATM header. A conventional stream information parser loads a sync word 0x2B7 of the LOAS or LATM header into an AAC decoder before decoding, so that the audio decoder identifies a LOAS frame or LATM frame in the input stream.

However, in complicated software and hardware operation flow, a decoding error of an AAC decoder may occur even if only one of the above steps goes wrong. For example, supposing the stream information parser or an upper layer application program mistakenly loads incorrect sync words into the AAC decoder, or a value in the stream type field of the TS packet does not match with a sync word of a practical audio header, decoding errors may occur such that even a channel may not produce any sound until a user switches the channel.

### SUMMARY OF THE INVENTION

In view of the foregoing problem, one object of the present invention is to provide a method for auto detecting a frame header. In this method, decoding efficiency of a system is increased and the probability of incurring program errors is reduced by searching and comparing the content of predetermined sync words of input frames.

To achieve the foregoing object, the method for auto detecting a frame header according to the invention is applied to a receiving end device for receiving a stream of frames, with each of the frames comprising a frame header and a raw data block. The auto detection method comprises receiving an input frame; correspondingly parsing and audio decoding the input frame when one of a plurality of header flags matches a first predetermined value; and setting a corresponding header flag as the first predetermined value, and parsing and audio decoding the input frame when a plurality of starting bits of the input frame match one of a plurality of sync words.

The advantages and spirit related to the present invention can be further understood via the following detailed description and drawings.

### BRIEF DESCRIPTION OF THE DRAWINGS

FIG. 1 is a diagram of a relationship among a TS, an audio PES and a frame.

FIG. 2A and FIG. 2B are a flowchart of an auto detection method for a frame header in accordance with an embodiment of the present invention.

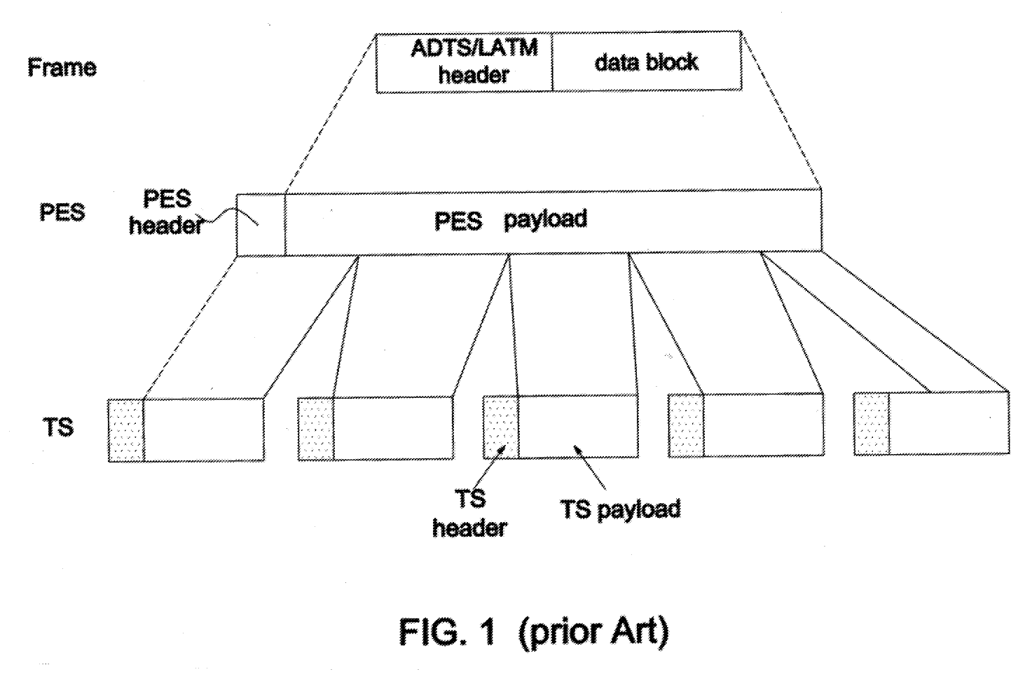

### DETAILED DESCRIPTION OF THE PREFERRED EMBODIMENT

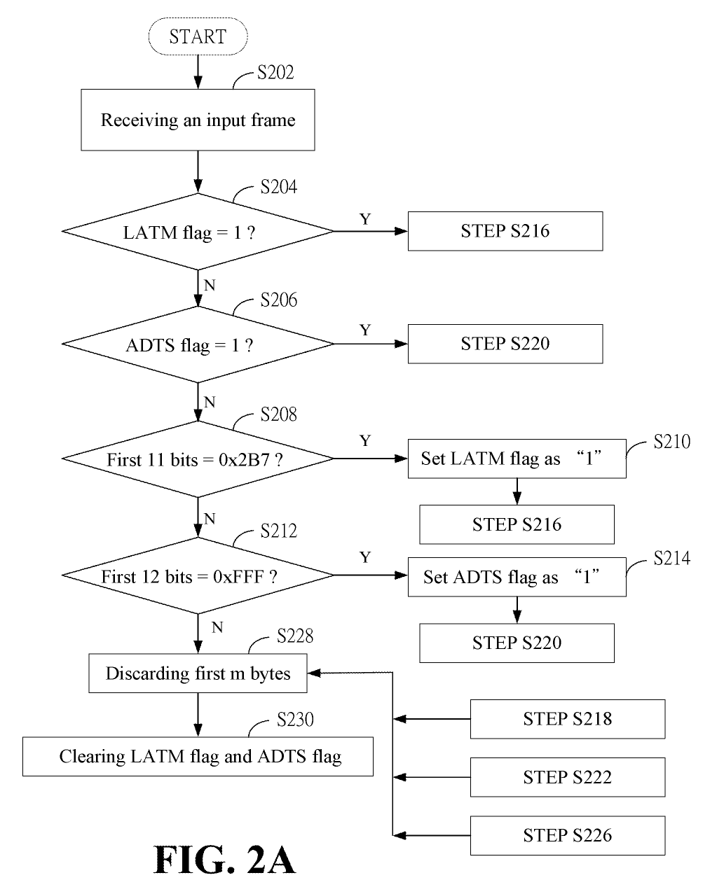

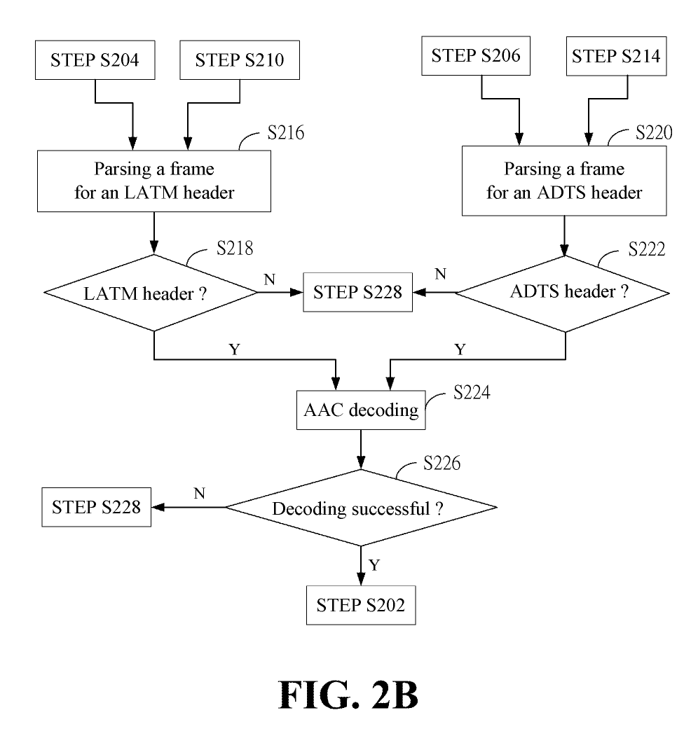

FIG. 2A and FIG. 2B are a flowchart of an auto detection method for a frame header in accordance with an embodiment of the present invention. In this embodiment, the AAC (MPEG-2) standard and the HE-AAC (MPEG-4) standard are simultaneously supported at a receiving end. Suppose that initial values of a LATM flag and an ADTS flag equal “0” (FALSE). During the entire audio decoding cycle, auto-detected mechanism is enabled.

In Step S202, an input frame is received.

In Step S204, it is determined whether the LATM flag is true. If true, Step S216 is performed; otherwise, Step S206 is performed. In this embodiment, a highest priority is given to the latest HE-AAC standard to be compared and performed. Persons having ordinary skill in the art may adjust the priority according to actual requirements.

In Step S206, it is determined whether the ADTS flag is true. If true, Step S220 is performed; otherwise, Step S208 is performed.

In Step S208, it is determined whether first 11 bits of the input frame equal 0x2B7. If true, S210 is performed; otherwise, Step S212 is performed. Step S208 and Step S212 search for sync words from the beginning of the input frame. In this embodiment, since the higher priority is given to the HE-AAC standard, the comparison starts with HE-AAC sync words 0x2B7 having a highest priority.

In Step S210, the LATM flag is set as “1”. Preferably, either the LATM flag or the ADTS flag is set as “1”.

In Step S212, it is determined whether the first 12 bits of the input frame equal 0xFFF. If true, Step S214 is performed; otherwise, Step S228 is performed. In this embodiment, when the caparison of the HE-AAC sync words 0x2B7 having the highest priority fails, AAC sync word 0xFFF having a lower priority is compared.

In Step S214, the ADTS flag is set as “1”.

In Step S216, a frame header of the input frame is parsed for an LATM header. When the sync words are searched, it is possible that the determined 0x2B7 or 0xFFF represent one portion of the frame raw data block but not the real frame header sync words. Therefore, comparison is further carried out to determine whether data after the determined 0x2B7 or 0xFFF comply with the format of the ADTS or LATM header.

In Step S218, it is determined whether the frame header complies with the format of the LATM header. If true, Step S224 is performed; otherwise, Step S228 is performed.

In Step S220, the frame header of the input frame is parsed for the ADTS header.

In Step S222, it is determined whether the frame header complies with the format of the ADTS header. If true, Step S224 is performed; otherwise, Step S228 is performed.

In Step S224, audio decoding is performed on the frame raw data block of the input frame to determine whether the frame raw data block can be accurately decoded according to frame header information obtained in Step S216 or Step S220.

In Step S226, it is determined whether the audio decoding is successful. If true, the flow returns to Step S202; otherwise, Step S228 is performed.

In Step S228, first m bytes of the input frame are discarded, where m is a positive integer.

In Step S230, the LATM flag and the ADTS flag are cleared as “0”, and the flow returns to Step S202.

In Step S228, preferably, a value of m is determined according to a processing time of the receiving end device. For example, when sync words are being searched and compared, since the processing time of the receiving end device is short, a frontmost byte (m=1) of the input frame is discarded once the first 11 or 12 bits of the input frame do not match with two predetermined sync words. A next comparison begins with a next byte. Usually, one or two frames at a time, a sync word will be found. A person having ordinary skill in the art may appreciate that various approaches may be utilized to achieve same effect. For example, a comparison pointer is utilized as an index, and a value of the comparison pointer increments by 1 each time the comparison of sync words fails. Considering the worse case, when the comparison of sync words is successful and the frame header also complies with the LATM header or the ADTS header but audio decoding of the frame raw data block fails, a great amount of time has already consumed. At the same time, TS packets continuously enter the receiving end device. Since the receiving end device does not store the TS packets, a previous TS packet with decoding error is overwritten by a subsequent TS packet. Therefore, the receiving end device re-compares and re-searchs for sync words from a new TS packet.

In this embodiment, comparing two types of sync words of the LATM header and the ADTS header is disclosed. In another embodiment, sync words of p (no less than 2) headers are compared and p header flags are programmed simultaneously. A priority sequence is defined to determine which sync word or header flag is to be first compared and first performed. Preferably, one of the p header flags is defined as “1”. In other words, when the first 11 or 12 bits of the current input frame match with the two sync words, a header flag having a highest priority is set according to the foregoing priority sequence, and the frame header is parsed and the frame raw data block is correspondingly decoded.

In this embodiment, once a header sync word of the input frame is successfully found and the subsequent parsing and audio decoding are accomplished, a corresponding header flag is set as “1”. Accordingly, for subsequent frames, a comparison time of the header sync word is saved and decoding efficiency of a whole system is increased. Even if parsing errors or decoding errors occur, the header sync word can be identified in a short time to immediately recover normal operations via an auto recovery mechanism disclosed by the present invention.

To sum up, an auto detection method for a frame header is provided according to the present invention. The method is applied to a receiving end device operating according to a plurality of header flags. The auto detection method comprises receiving an input frame by the receiving end device, the input frame comprising a frame header and a frame raw data block; correspondingly parsing and audio decoding the input frame when one of the header flags equals a first predetermined value; and setting a corresponding header flag as the first predetermined value and parsing and audio decoding the input frame when a plurality of starting bits of the input frame equal one of a plurality of sync words.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for auto-detecting a frame header, applied to a receiving end device operating according to a plurality of header flags, the method comprising:
receiving an input frame by the receiving end device, the input frame comprising the frame header and a frame raw data block;
parsing and audio decoding the input frame when one of the header flags matches a first predetermined value; and
setting one of the header flags to the first predetermined value and correspondingly parsing and audio decoding the input frame when a plurality of starting bits of the input frame match one of a plurality of sync words.

2. The method as claimed in claim 1, further comprising:
discarding first m bytes of the input frame and setting the header flags as a second predetermined value when the parsing fails, where m is a positive integer.

3. The method as claimed in claim 1, further comprising:
discarding first m bytes of the input frame and setting the header flags as a second predetermined value when the audio decoding fails, where m is a positive integer.

4. The method as claimed in claim 1, further comprising:
discarding first m bytes of the input frame and setting the header flags as a second predetermined value when the plurality of starting bits of the input frame do not match the sync words, where m is a positive integer.

5. The method as claimed in claim 1, further comprising:
repeating all foregoing steps.

6. The method as claimed in claim 1, wherein the setting step sets the header flag as the first predetermined value, and parses and decodes the input frame according to a priority sequence.

7. The method as claimed in claim 6, wherein the setting step further comprises:
comparing the plurality of starting bits of the input frame to each of the plurality of sync words according to the priority sequence;
setting the corresponding header flag as the first predetermined value when the plurality of starting bits of the input frame match one of the sync words, wherein each of the header flags corresponds to one of the sync words; and
parsing the frame header and decoding the frame raw data block according to the matched sync word.

8. The method as claimed in claim 7, wherein the header flags comprise a first header flag and a second header flag, and the sync words comprise a first sync word and a second sync word, with a priority of the first sync word being higher than that of the second sync word.

9. The method as claimed in claim 8, wherein the first sync word matches 0x2B7 and the second sync word matches 0xFFF.

10. The method as claimed in claim 4, wherein in the discarding step, m equals 1 when the plurality of starting bits of the input frame does not match any of the sync words.

11. The method as claimed in claim 2, wherein m is determined according to processing time of the receiving end device.

12. The method as claimed in claim 3, wherein m is determined according to processing time of the receiving end device.

13. The method as claimed in claim 1, wherein the header flags are set as the second predetermined value during initialization.

14. The method as claimed in claim 1, wherein the frame header is an Advance Audio Coding (AAC) frame header.
